(19) United States
(12) Patent Application Publication
(10) Pub. No.: US 2012/0001724 A1
(43) Pub. Date: Jan. 5, 2012

(54) Interacting with Peer Devices Based on Machine Detection of Physical Characteristics of Objects

(76) Inventor: Petros Belimpasakis, Tampere (FI)

(21) Appl. No.: 12/828,571

(22) Filed: Jul. 1, 2010

(51) Int. Cl. G06F 7/04; G06K 9/00

(52) U.S. Cl. 340/5.1; 382/100

(57) ABSTRACT

An inherent physical characteristic of a target object is detected via a sensor of a user device. The inherent physical characteristic is not intended for machine reading. The target object is identified based on comparing the inherent physical characteristic to data representative of a type of the target object. Data processing actions are engaged in with the target object via a network in response at least to identifying the type of the target object.

### TECHNICAL FIELD

This specification relates in general to electronic devices, and more particularly to networked user devices.

### BACKGROUND

The term “ubiquitous computing” or “pervasive computing” generally refers to the integration of data processing devices into everyday objects and activities. This is sometimes distinguished from what is called a “desktop paradigm,” where computers and the like are intended for full engagement by users to perform computer-specific tasks, e.g., a user composing a document on a word processor or browsing the Internet. In contrast, a pervasive/ubiquitous computing environment may be able to enhance, either directly or indirectly, all sorts of human activity that are not normally associated with operating a computer, e.g., household chores, physical exercise, medical treatment, travel, etc. In such an environment, the computers may be less prominent or even invisible to the user, even though the results of computers actions are not.

At least two technological developments are bringing some aspects of pervasive/ubiquitous computing closer to reality: mobile devices and wireless networking. Mobile devices are continually advancing in features and computing power, and in some cases have enough capability to serve as a primary computer for many people. Mobile devices are typically small and battery-operated, thus readily available for uses such as human-machine interface and local sensing. Combined with the ready availability of wireless high speed networks, mobile devices can be made to interact with other data processing devices in almost limitless ways, thereby extending the power and usefulness of all the connected devices.

### SUMMARY

The present specification discloses systems, apparatuses, computer programs, data structures, and methods for facilitating device interactions based on machine detection of physical characteristics of objects. In one embodiment, an apparatus includes at least one processor and at least one memory including computer program code. The at least one memory and the computer program code are configured to, with the at least one processor, cause the apparatus at least to detect an inherent physical characteristic of a target object via a sensor. The inherent physical characteristic is not intended for machine reading. The at least one memory and the computer program code are further configured to, with the at least one processor, cause the apparatus at least to identify the target object based on comparing the inherent physical characteristic to data representative of a type of the target object, and engage in data processing actions with the target object via a local network in response at least to identifying the type of the target object.

In another example embodiment, a computer program product includes at least one computer-readable storage medium having computer-executable program code instructions stored therein. The computer-executable program code instructions may include program code instructions for detecting an inherent physical characteristic of a target object via a sensor of a user device, wherein the inherent physical characteristic is not intended for machine reading; identifying the target object based on comparing the inherent physical characteristic to data representative of a type of the target object; and engaging in data processing actions with the target object via a local network in response at least to identifying the type of the target object.

In another example embodiment, a method involves detecting an inherent physical characteristic of a target object via a sensor of a user device. The inherent physical characteristic is not intended for machine reading. The target object is identified based on comparing the inherent physical characteristic to data representative of a type of the target object, and data processing actions are engaged in with the target object via a local network in response at least to identifying the type of the target object.

In more particular embodiments, the inherent physical characteristic of the target object may include an overall appearance of a target device and/or as-manufactured physical configuration of a device. Detecting the inherent physical characteristic of the target object via the sensor may involve capturing an image of the target object, and identifying the target object may involve comparing the image to a stored image. In such a case, the stored image may include a previously captured image of the target object obtained via the sensor and/or a previously captured image of an equivalent object.

In more particular embodiments, the data representative of the type of the target object may include one or more of a mathematical model of geometry of the target object and feature data of an image of the target object. In one arrangement, the target object includes a peer device of the apparatus, and data representative of the type of the target object is obtained through service discovery via an ad-hoc, peer-to-peer network. In other arrangements, the target object includes a media renderer, and engaging in data processing actions with the target object via the local network includes sending media to the media renderer to be rendered.

In another embodiment of the invention, a method involves obtaining, based on service discovery with a target device via an ad-hoc peer-to-peer network, a representative image of the target device. Selection by a user of media to be rendered via a user device is facilitated, and a live, digital image of target device is obtained via a camera sensor of the user device. The target device is determined as being intended by the user for rendering the media based on a comparison between the live, digital image and the representative image. The media is caused to be rendered on the target device based at least on the comparison.

These and various other advantages and features are pointed out with particularity in the claims annexed hereto and form a part hereof. However, for a better understanding of variations and advantages, reference should be made to the drawings which form a further part hereof, and to accompanying descriptive matter, in which there are illustrated and described representative examples of systems, apparatuses, computer program products, and methods in accordance with example embodiments of the invention.

### BRIEF DESCRIPTION OF THE DRAWINGS

The invention is described in connection with example embodiments illustrated in the following diagrams, wherein the same reference numbers may be used to identify similar/same components in multiple figures.

FIG. 1A is a block diagram of a home network according to an example embodiment of the invention;

FIG. 1B is a block diagram of device descriptive databases according to an example embodiment of the invention;

FIG. 2 is a sequence diagram illustrating procedures according to an example embodiment of the invention;

FIG. 3 is a block diagram illustrating device user interface screens according to an example embodiment of the invention;

FIG. 4 is a block diagram of a local network apparatus according to an example embodiment of the invention;

FIG. 5 is a block diagram of a mobile apparatus according to an example embodiment of the invention; and

FIGS. 6A-B are flowcharts illustrating procedures according to example embodiments of the invention.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present invention is generally related to devices that are operable in smart, in-home networks. These devices may be adapted to utilize machine learning to identify other objects based on physical characteristics such as general appearance of the objects. The identified objects may include other devices, or other objects capable of computer interaction, such as digital media. Based on such identification, devices can interact without users having to explicitly direct such interactions using conventional paradigms, such as selection of target devices/media via a menu.

In-home networks may include Universal Plug and Play (UPnP™) networks. The term UPnP is generally used to indicate a set of networking protocols promulgated by the UPnP Forum. The goals of UPnP are to allow devices to connect seamlessly and to simplify the implementation of networks in the home. These networks may be used for data sharing, communications, entertainment, and other computing applications known in the art. While targeted towards home users, the UPnP framework is not limited to home environments. For example, corporate environments may utilize UPnP to simplify installation and use of computer components such as printers. UPnP achieves this by defining and publishing UPnP device control protocols (DCP) built upon open, Internet-based communication standards.

The embodiments described below may be described as UPnP-type devices for purposes of illustration and not of limitation. Those familiar with the applicable art will appreciate that the network and device concepts described herein may be applicable to any manner of ad-hoc, peer-to-peer networking arrangement suitable for consumer and/or business networks. For example, X-10™, Service Location Protocol (SLP), Zeroconf, and Jini™ are protocols that, either alone or in combination with other known protocols, may provide functions similar to those of UPnP.

Many mobile devices such as smart phones may already utilize UPnP protocol for discovering home devices and utilizing services of those devices, and vice versa. For example, a smart phone may store or otherwise access digital media (e.g., a digital movie), and render the media on a rendering device (e.g., play the movie from the phone to the living room TV). A particular subset of the UPnP framework, known as UPnP Audio/Video (AV), includes device/service definitions to facilitate this type of scenario. The Digital Living Network Alliance® (DNLA) has adopted the UPnP AV as a content management and control solution for DNLA certified products.

The UPnP AV framework deals with three specific logical entities, Media Server, Media Renderer, and Control Point. The UPnP Control Point is a component that allows users to interact with a system, e.g., browse the files of a media server, send media to be rendered to a media renderer, etc. A Media Server may include devices that can store, catalog, and serve-up files and/or streams of data to be rendered (e.g., movies, songs, photos). A Media Render may include devices/components that can render the media, e.g., a UPnP-enabled TV or hi-fi system. It will be appreciated that the Media Server, Media Renderer, and Control Point define logical entities that may reside on the same or different devices (e.g. a mobile phone can be configured to operate as any combination of a Media Server, Media Renderer, and Control Point).

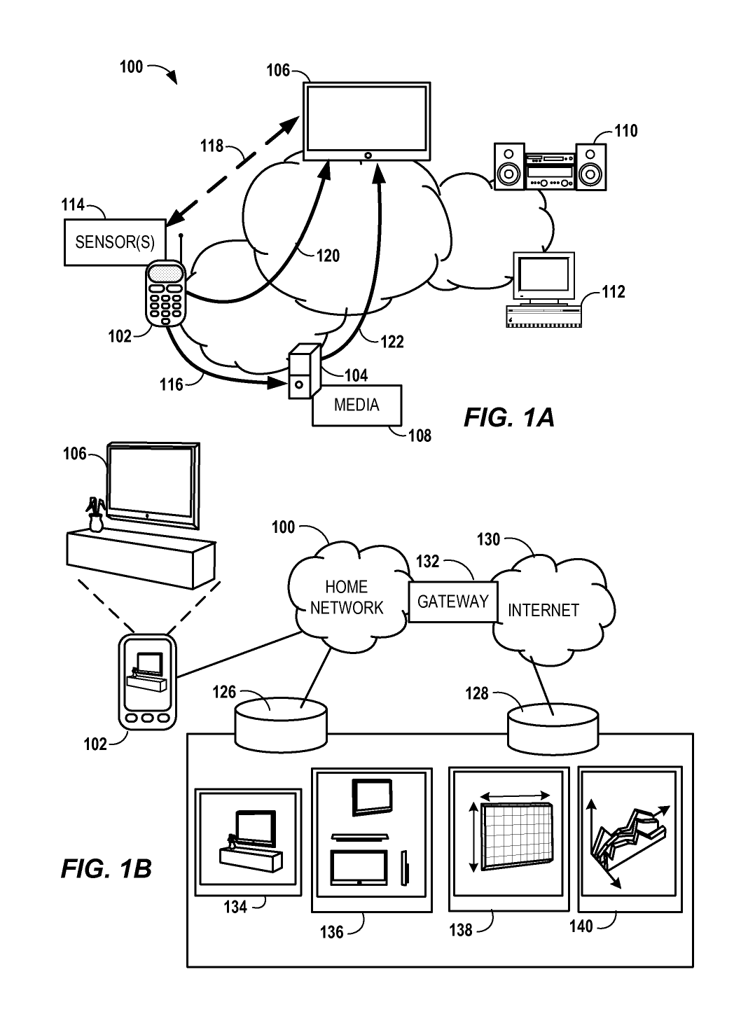

In reference now to FIG. 1A, a block diagram illustrates an example of device interactions according to an example embodiment of the invention. In this example, a mobile device 102 may be configured at least as a UPnP Control Point on a home network 100. A server 104 may include UPnP Media Server capabilities, and a television 106 may include UPnP Media Renderer capabilities. These devices 102, 104, 106 may provide functions similar/equivalent to these UPnP logical entities without utilizing UPnP, although some common framework may be needed to perform the inter-device interactions described below.

In one UPnP AV scenario, a user may use the Control Point of the mobile device 102 to browse available media. The media may be locally stored on the device 102 itself, and/or available elsewhere as represented by media 108 stored at server 104. Once the desired media is discovered and selected, the user may then need to select the target device for rendering, which in this example may include the television 106. However, the television 106 may not be the only device that is available for rendering. Other devices such as hi-fi 110 and desktop computer 112 may also be available to render some or all of the selected media. These rendering devices are merely an example representation. The invention may be applicable to any rendering device known in the art, including printers, digital picture frames, force feedback devices, lighting systems, robotic devices, etc.

In order to render the media 108, the user may first have to select the desired rendering device 106, 110, 112 from a list shown on a display of the mobile device 102. The names used to identify the devices in this list may be supplied from the devices 106, 110, 112 themselves. In such a case, the names may not be particularly useful to the end user. For example, a particular device 106, 110, 112 may be identified by some combination of model number, part number, version number, software vendor, manufacturer name, etc., some of which the user may not know or care about. As a result, such a list of available renderers may not be useful to some users, particularly to users that are not technologically savvy.

For example, many users may not pay particular attention to model numbers, and two or more of the devices 106, 110, 112 may come from the same manufacturer. So, while the user may know that the television 106 is BRAND-X, the hi-fi 110 may also be made by BRAND-X. Therefore a listing that shows both “BRAND-X HY68686” and “BRAND-X UJ89” may not be particularly informative when deciding where to target media playback. While the control point device 102 (or some other facility of the home network 100) may allow the user to change these descriptions, it may be difficult for some users to discover and utilize such a feature or capability.

The above-discussed potential for confusion in naming devices may become exacerbated in cases where the underlying framework (e.g., UPnP) does not have the notion of different network zones. In such a case, all of the in-home devices may appear to the user in a flat hierarchy, and this could be quite large depending on the number of home devices. Such a list also may not take into account whether it is reasonable or not to render to the device (e.g., some available devices may be in another room).

The embodiments of the invention described here address these and other difficulties in identifying particular devices on a home network 100. The ability to easily yet positively identify a device may be useful in ad-hoc, peer-to-peer networks where devices may join and leave the network 100 automatically. In such a case, there may not have been any previous need to obtain user inputs during setup of particular devices. While there are advantages to this automatic setup, it may not provide the user any opportunity to rename the device, and the default names used to describe the devices may be cryptic from the user's perspective.

In order to improve the user experience in such a case, it is first recognized that the mobile device 102 may include one or more sensors 114 that can be used to identify the target device. It now commonplace for mobile devices to include sensors 114 such as cameras and microphones. When combined with sophisticated pattern matching algorithms, such sensors 114 may allow the device 112 to positively identify the target device (e.g., television 106) based solely on physical characteristics of the device 106 measured via the sensor 114.

While the sensor 114 may be configured to read any physical characteristic of the target device, including specialized indicia such as bar codes or radio frequency ID (RFID) tags, the physical characteristics described herein are generally intended to encompass inherent physical characteristics that are not designed/intended for machine reading. For example, an identification of a device may be made by analyzing any combination of geometry, color, texture, reflectivity, logo placement, materials, sound, electromagnetic interference noise emissions, etc. These features may include any combination of functional characteristics inherent in the physical design, as well as decorative features intended to appeal aesthetically to the end user and/or facilitate brand recognition.

The identification of physical objects via machines is part of what is sometimes referred to as “mixed reality.” Mixed reality generally refers to the real time merging of real and digital elements. For example, mobile devices are nowadays able to recognize (e.g., via cameras and computer vision algorithms) different real life objects. Once such objects are recognized, the device may provide related digital information about the object, e.g., based on a current context. An example is a mobile device service which facilitates discovering useful and contextually relevant information and services by pointing a camera phone at objects. For instance, by pointing camera phone at a movie poster on the street, the user may be able to instantly find relevant data, such as reviews, ratings, show times, and the closest theatre where the movie is playing. Other actions may also be facilitated, such as the purchase tickets for at one of the identified theatres.

One embodiment of the invention uses computer sensing and object identification techniques (such as is used in mixed reality applications) to identify the rendering device to which the user would like to stream content. In reference again to the example network 100 in FIG. 1, the user may choose via mobile device 102, a video file for playback. The video file may be on the device 102, or may be discovered from the media server 104, as represented by path 116 used to discover media 108. The user may then point the sensor 114 (e.g., camera) of the mobile device towards a rendering device, e.g., nearby UPnP enabled television 106, as represented by path 118.

After identifying 118 the television 106, the user may get an optional confirmation window asking if the media 108 should be played on the external device 106. This confirmation/prompt could be a conventional dialog, and/or could be combined with imagery taken by the sensor 114. For example, a video display of the device 102 may include a live feed of the sensor data as detection is proceeding, and any detected devices may be identified using an overlay (e.g., shaded graphic, outline, text, etc.) on the video display. Such an overlay may be selectable by the user (e.g., tap on a touchscreen) to ultimately determine the target device. The use of overlays may be particularly useful in some situations, e.g., where there are two or more possible target devices in the current view.

After the target device 106 is detected and/or selected, the media is then wirelessly streamed to the TV set, utilizing the standard UPnP protocols. This is represented by paths 120 and 122, which may be used to communicate control data and content to/from the television 106. It may be appreciated that the media rendering may be split between different devices, e.g., sending video to the television 106 and associated audio to the hi-fi 110. In such a case, overlay graphics or similar features may allow selecting multiple rendering devices for handling various aspects of the rendering tasks. For example, video rendering devices (e.g., television 106 and computer 112) may be wholly or partly overlaid by a first color/icon, and sound rendering devices (e.g., television 106, hi-fi 110, and computer 112) may be wholly or partly overlaid by a second color/icon. The user may use a touchscreen or other input device to select the appropriate device for rendering each of these data types.

The use of mixed reality may help eliminate the need of knowing cryptic names of the in-home devices. This use of captured imagery “scales” well even when having multiple home devices. For example, two television sets are not typically located next to each other, and so there may be less chance of confusion when a matching algorithm tries to identify a particular set. The use of captured images can free users from having to customize menus, such as by creating and saving their own device names. This may also free users from having to perform other identity-enabling tasks, such as adding and programming a device to use machine-readable indicia that may be manufactured with a device and/or be added on later. Further, some users may object to visible machine-readable indicia, as it may detract from the aesthetics of certain home electronics.

The examples above describe media rendering as an application in which mixed reality concepts may be employed, however the invention need not be so limited. The above-described features may be used in analogous situations, such as in universal remote control applications. The mobile device 102 may be usable, either via the network 100 or directly (e.g., using infrared transmitter), as a remote control for multiple devices in the home. However, it may be cumbersome to traverse menus on the mobile device 102 in order to select a particular set of remote codes and/or operational modes to control devices.

Similar to the discovery of a targeted media renderer, the mobile device 102 acting as remote control may be adapted to recognize devices 118 via sensor(s) 114, and thereby select the command sets and user interface components of the mobile device 102 needed to control the targeted devices. A multiple selection of targets via the device 102 may be useful in this case as well. For example, the television 106 may be selected for both sound and video control for watching broadcast shows. For watching movies, however, video control functions (e.g., brightness, color balance) may only be set up for the television 106, audio control functions (e.g., volume, mute) may be mapped/applied to the hi-fi 110, and media controls (e.g., pause, play, skip) may be mapped/applied to the media server 104.

Although many of the examples described herein utilize a still or moving digital image to identify target objects, it will be appreciated that other sensors may also be used instead of or in combination with digital images. For example, some devices make a distinctive sound, either when running or starting up, and this sound could also be used to identify a target device. In other embodiments, the UPnP services and/or device profiles of the various devices could include features that cause the rendering hardware to assist in this identification. For example, the mobile device 102 could invoke a particular action that facilitates visual and/or audible identification of targeted devices 106, 110, 112. This invoked action might involve causing each video rendering device to display a particular image on a screen (e.g., number, icon). Such image could be overlaid on an existing video, assuming the device is already turned on, and could be sent in parallel or in serial to all known devices. Each image could be associated with a particular target device, and this image could be recognized 118 by way of sensors 114, e.g., detected on a TV screen via a mobile device camera. This type of identification could also use sounds to identify audio-only playback devices, or could cause the audio-only device to assume a particular visual characteristic (e.g., briefly assume a particular arrangement/illumination pattern of indicator lights or fluorescent menu display).

In reference now to FIG. 1B, a block diagram illustrates particular implementation details of a system according to embodiments of the invention. In this example, the mobile device 102 may use a matching algorithm to determine the identity of a particular target device, represented here as television 106. This algorithm may utilize one or more databases 126, 128 in order to determine identity of the target device 102. Database 126 is accessible via the local network 100, and/or may be directly stored on the mobile device 102. Database 128 may be accessible via public networks such as the Internet 130, e.g., via gateway 132 that provides Internet access to the devices of the local network 100. The mobile device 102 may be able to access the external database 128 via the gateway 132 and/or directly (e.g., via a carrier network). Other than the network location of databases 126, 128, there need be no significant difference between the features and/or data of the databases 126, 128.

By way of example, the databases 126, 128 may be capable of storing and accessing at least four different types of data. The first type is represented by image 134, which may be a user-captured image of the target device 106. This image 134 may contain context data that helps quickly identify the device 106, such as surrounding items, lighting, viewing angle, etc. This may assist in more quickly identifying objects of interest, although may require initial user setup, e.g., capturing, storing, and/or categorizing the image 134 upon setup and/or first use.

Image 136 represents a stock photo of an item substantially identical to and/or representative of device 106. This type of image 136 may be obtained from manufacturers, retailers, or any other third party that may have an interest in storing and indexing this type of data. The image 136 may include multiple views, and may include metadata that indicates, e.g., one or more views that may be expected to be visible to the user in a typical installation. Other metadata may include other imagery or data regarding available colors, accessories, configurations, etc.

A third kind of data is represented as geometry data 138 that may be used to represent the target object 106. This data 138 may be used to form a virtual model of the device 106, e.g., in a virtual three-dimensional space. The data 138 may also include other metadata, such as textures, colors, materials, etc. The fourth type of data that may be accessible via databases 126, 128 is represented by feature data 140. This data 140 may be extracted from photos or other digitized analog data, and stored in a compact form. Thereafter, analogous feature data can be extracted from sensor data of the mobile device 102, and compared to the stored data 140.

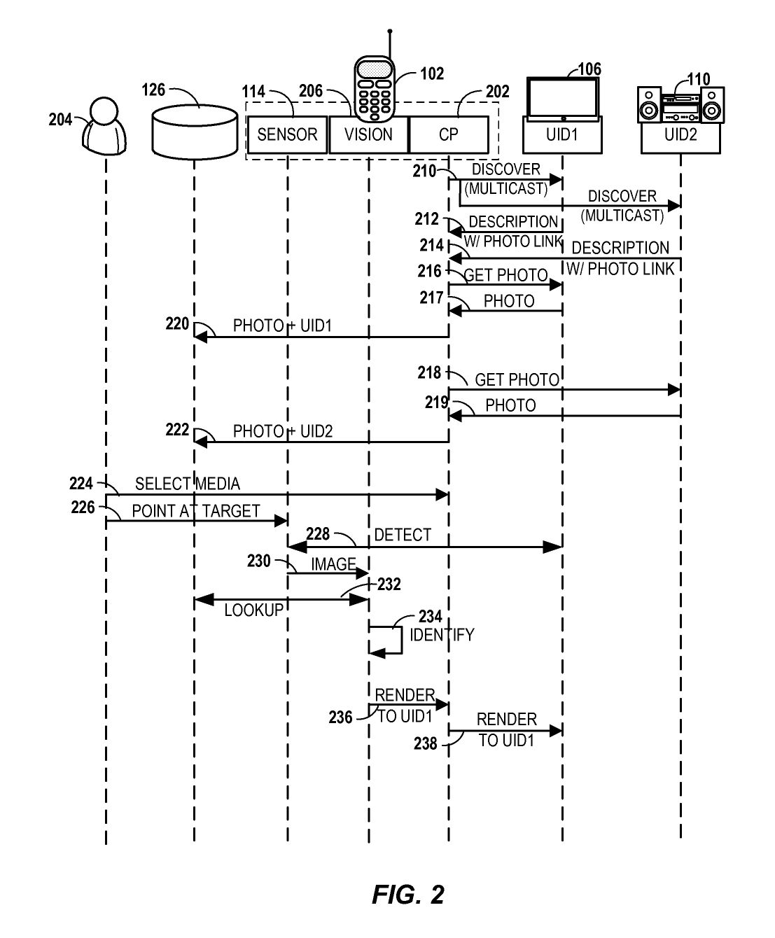

Generally, a system according to embodiments of the invention may need to at least provide a convenient way to register/store data related to the target so that a recognition algorithm (e.g., computer vision algorithm) can understand it. Such a system may also require mapping the registered devices to their unique identification (UID), which are identifiers utilized in UPnP advertisement messages. In reference now to FIG. 2, a sequence diagram illustrates registering and mapping device descriptive data according to an example embodiment of the invention.

Generally, the scenario in FIG. 2 envisions that manufacturers of UPnP-enabled products will provide a sample photo of device and/or a link to such a photo. Such photo may include, e.g., a real-life electronic photo (e.g., in a JPG or similar format) of the device, and/or geometry/feature data describing the device. This photo could later be used to identify the device with computer vision techniques. As seen in FIG. 2, a control point 202 of mobile device 102 may search for in-home devices 106, 110 when the device 102 joins the home network. In this example, the search involves sending a multicast discover message 210, which is part of the standard UPnP SSDP (Simple Service Discovery Protocol). In response to the search 210, the in-home devices 106, 110 reply with their device descriptions 212, 214 in an XML format per the UPnP standard. The devices 106, 110 may be discovered in other ways, such as from service advertisements issuing from devices 106, 110, and the present invention is not limited to UPnP search scenarios.

Each of the device descriptions 212, 214 may include an additional field providing a link the product photo (or, in other embodiments, may include the photo itself). In this scenario, the photo may be stored on the devices 106, 110, in which case the links may include local addresses of the respective devices 106, 110 (e.g., http://192.168.1.22/product.jpg). As shown by interactions 216-219, the control point 202 retrieves the photos from devices 106, 110 using a protocol described in the link, e.g., Hypertext Transport Protocol (HTTP), In other arrangements, the link may include an Internet Uniform Resource Locator (URL), which may entail obtaining the image from outside the home network.

After obtaining the photos 217, 219, the control point 202 saves the photos in a local database 126, as indicated by messages 220, 222. These messages also include the unique UPnP UID of every respective devices 106, 110 from which the photos were obtained. These UIDs may be acquired with the device description XML documents 212, 214. At this phase, the control point 202 knows which devices 106, 110 are in the home network, and the physical appearance of these devices 106, 110.

At a later point in time, a user 204 might use the user interface of the mobile device 102 to select 224 a media item (e.g., a video), from local storage of the device 102, or anywhere in a “cloud” of home and/or hosted storage. The user could then point 226 the sensor 114 (e.g., camera) of the mobile device 102 towards the external device 106 on which rendering of the media is desired. The sensor 114 detects 228 the targeted rendering device 106 and communicates 230 this to a computer vision module 206 of device 102.

The computer vision module 206 may perform operations 232, 234 to determine the identity of the target device 106. These operations 232, 234 may include a comparison of a static photo and/or live matching of a real-time camera feed against its database 126 of the photos of discovered devices. Such matching mechanisms are known in the art, such as is utilized in the Nokia™ Point & Find service. Once a match is found, the mobile device 102 would be able to direct the media to be rendered to the target device 106, as shown by messages 236 and 238. The control point 202 would have (e.g., from the UPnP announcement and the related photo association) all the needed UPnP details for contacting and controlling the selected rendering device 106.

The interactions shown in FIG. 2 are just one example of how images (or other recorded sensor data) may be obtained and utilized. Many variations are possible in view of the above teachings. For example, the photos of the devices stored in database 126 could be obtained from and/or stored on Internet databases. The links contained in messages 212, 214 include URLs allowing the control point 202 to retrieve the photo directly from the Internet. This would require less storage space at the devices 106, 110, although may need some mechanism to ensure that a locally detected type of device (e.g., particular model number) is associated with a particular device (e.g., as identified by UID).

In another variation, the link would not be provided in messages 212, 214 from the target devices 106, 110, but could be derived based on certain data that may be obtained from these (or other) messages 212, 214. In this variation, the control point 202 may be able to retrieve product specific information the standard UPnP description, including name, model, version, UID, etc. The control point 202 could then try retrieving a sample photo by querying a general Internet service, or one that is specific to this type of application. For example, the control point 202 could use a specially formatted URL such as http://upnplookupservice.com/photo?uid=xxxxx&model=xxxx&format=jpg to retrieve the desired photos. This has the advantage in that it requires no additional data be provided from devices 106, 110 over and above what may already be communicated by a UPnP-compliant device. This approach may be dependent on device manufacturers using non-generic names in their UPnP advertised device descriptions.

As was previously described, the database 126 may also store sample photos of devices created by end-users. This may be useful where the default sample photo of a product might not be directly applicable. For example computer vision/photo recognition techniques using a stock photo might fail, such as where the user has placed a hi-fi system inside furniture and so that the equipment is not directly visible. The system could allow the users to create their own sample photos. In such a scenario the user may be able to take a photo of the furniture housing the hi-fi system, and map it to the device description of the rendering device. This may be useful in other scenarios, e.g., where the device appearance has been altered by the end user (e.g., change color, addition of third-party accessory or covering), and/or in a mixed-compatibility environment where some, but not all, UPnP devices provide images and/or links to images via service discovery messages.

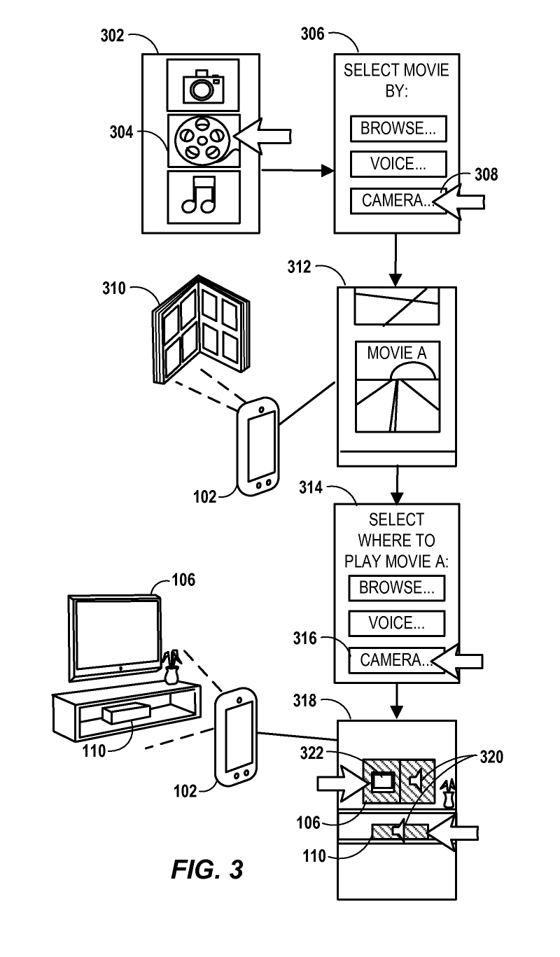

In reference now to FIG. 3, a block diagram illustrates user interface views of a user device according to an example embodiment of the invention. In this scenario, a mobile apparatus 102 may include mixed reality features that allow selection of both target media and target rendering device. In the first screen 302, controls (e.g., buttons) allow selecting a particular type of media to render. In this example, movie control 304 is selected, causing screen 306 to appear. Screen 306 provides the user with a number of options for selecting a movie to watch. In this example, the movie will be selected by way of the camera based on activation of control 308.

In this example, the user may have images of movies, such as from a DVD cover or a magazine advertisement. These images are part of a physical object, as represented by book/album 310, and may be captured by the device 102 as represented in video screen 312. Based on recognition of the image in screen 312, the device 102 may perform a query for local or remote media associated with the image 312. Assuming such recognition results in finding appropriate media, the user may see screen 314, which is used to select where the media will be played.

Screen 314 includes controls analogous to those in screen 310, and as with screen 310, the user selects a camera control 316. The user points the device 102 at the potential renderers, here television 106 and hi-fi 110. This results in the video image in screen 318 showing these two devices 106, 110. Screen 318 also shows overlays (seen as hatched areas) with respective icons 320 and 322 representing respecting sound rendering and video rendering capabilities of the devices being overlaid. As represented by the arrows, the user has selected the television 106 for video playback and the hi-fi 110 for sound playback. Upon selection of media source and rendering device, the movie playback can begin. Further, these selections may also enable the device 102 to present further user interface screens (not shown) for controlling the selected devices.

The above examples describe a mobile device capturing images to assist in performing interactions with other, typically fixed, home media devices. However, these functions need not be limited to the described mobile and/or fixed devices. For example, a desktop computer with a webcam could use a similar procedure to send data to a cellular phone that is recognized by way of the webcam. In a similar manner, media items can be shared two mobile devices, which are connected on the same home (e.g., ad-hoc, peer-to-peer) network. Mobile devices may also have a “sample photo” provided during service discovery that will initiate sharing. Such implementations may need to take into account that there may be multiple devices in a household with the same appearance. Thus, even if a “type” of the targeted object (e.g., model number) can be positively determined, such determination may just narrow the list of particular known/associated objects. Certain other differentiating features, e.g., personalized menus or background images on a home screen, may be useful in differentiating such devices, e.g., by manually or automatically associating these additional features with a unique ID.

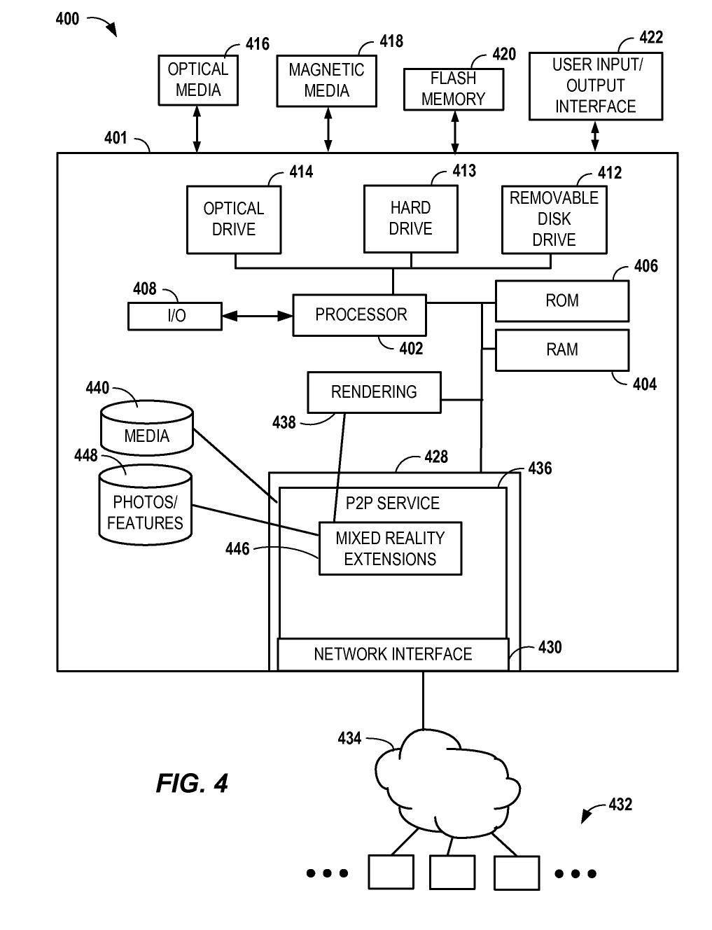

In reference now to FIG. 4, a block diagram provides details of a home network device 400 that may respond to mixed reality operations according to an example embodiment of the invention. The device 400 may be implemented via one or more conventional computing arrangements 401. The computing arrangement 401 may include custom or general-purpose electronic components. The computing arrangement 401 include one or more central processors (CPU) 402 that may be coupled to random access memory (RAM) 404 and/or read-only memory (ROM) 406. The ROM 406 may include various types of storage media, such as programmable ROM (PROM), erasable PROM (EPROM), etc. The processor 402 may communicate with other internal and external components through input/output (I/O) circuitry 408. The processor 402 may include one or more processing cores, and may include a combination of general-purpose and special-purpose processors that reside in independent functional modules (e.g., chipsets). The processor 402 carries out a variety of functions as is known in the art, as dictated by fixed logic, software instructions, and/or firmware instructions.

The computing arrangement 401 may include one or more data storage devices, including removable disk drives 412, hard drives 413, optical drives 414, and other hardware capable of reading and/or storing information. In one embodiment, software for carrying out the operations in accordance with the present invention may be stored and distributed on optical media 416, magnetic media 418, flash memory 420, or other form of media capable of portably storing information. These storage media may be inserted into, and read by, devices such as the optical drive 414, the removable disk drive 412, I/O ports 408 etc. The software may also be transmitted to computing arrangement 401 via data signals, such as being downloaded electronically via networks, such as the Internet. The computing arrangement 401 may be coupled to a user input/output interface 422 for user interaction. The user input/output interface 422 may include apparatus such as a mouse, keyboard, microphone, speaker, touch pad, touch screen, voice-recognition system, monitor, LED display, LCD display, etc.

The device 400 is configured with software that may be stored on any combination of memory 404 and persistent storage (e.g., hard drive 413). Such software may be contained in fixed logic or read-only memory 406, or placed in read-write memory 404 via portable computer-readable storage media and computer program products, including media such as read-only-memory magnetic disks, optical media, flash memory devices, fixed logic, read-only memory, etc. The software may also placed in memory 406 by way of data transmission links coupled to input-output busses 408. Such data transmission links may include wired/wireless network interfaces, Universal Serial Bus (USB) interfaces, etc.

The software generally includes instructions 428 that cause the processor 402 to operate with other computer hardware to provide the service functions described herein. The instructions 428 include a network interface 430 that facilitates communication with user devices 432 of a local network 434. The network interface 430 may include a combination of hardware and software components, including media access circuitry, drivers, programs, and protocol modules. The network interface 430 may also include software modules for handling one or more network common network data transfer protocols, such as Simple Service Discovery Protocol (SSDP), HTTP, File Transfer Protocol (FTP), Simple Mail Transport Protocol (SMTP), Short Message Service (SMS), Multimedia Message Service (MMS), etc.

The network interface 430 may be a generic module that supports specific network interaction between user devices 432 and peer-to-peer service module 436. The network interface 430 and peer-to-peer service module 436 may include, individually or in combination, common protocol stacks of an ad-hoc, peer-to-peer network, such as protocols associated with the UPnP framework. Generally, the peer-to-peer service module 436 may provide one or more specific services via the network 434. For example, the device 400 may include rendering hardware 438 that allows the device to act, via the module 436, as a UPnP AV Media Renderer. The device 400 may also have media storage 440 and can act, via the module 436, as a UPnP Media Server.

The peer-to-peer service module 436 may include and/or utilize a set of extensions 446 that facilitate mixed reality interactions as described hereinabove. The extensions 446 may provide photos/features 448, links, and/or other media that allows one of the peer devices 432 to identify the device 400 using some physical characteristic. These photos/features 448 and other data may be provided as part of standard peer-to-peer service discovery over the network 434. In some scenarios, the stored media 440 may also be used to provide this data. For example, if the device 400 is configured as a media server, data contained within the media database 440 (e.g., digitized album cover art) may facilitate identifying particular media for rendering based on a camera image taken of a physical object (e.g., album cover art from CD/DVD case).

For purposes of illustration, the operation of the device 400 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 401 is only a representative example of network infrastructure hardware that can be used to provide device selection services as described herein. Generally, the functions of the computing device 400 can be distributed over a large number of processing and network elements, and can be integrated with other services, such as Web services, gateways, mobile communications messaging, etc. For example, some aspects of the device 400 may be implemented in user devices and/or intermediaries such as shown in FIGS. 1A-B, 2, and 3.

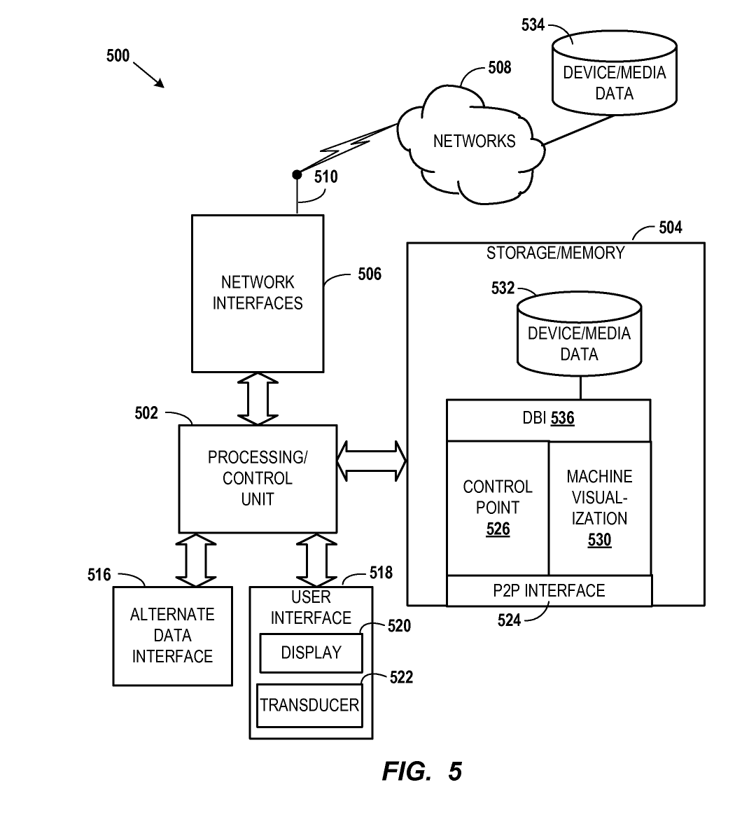

Many types of apparatuses may include features for performing mixed reality identification as described herein. Users are increasingly using mobile communications devices (e.g., cellular phones), and these devices are often replaced on a regular basis. In reference now to FIG. 5, an example embodiment is illustrated of a representative mobile apparatus 500 capable of carrying out operations in accordance with example embodiments of the invention. Those skilled in the art will appreciate that the example apparatus 500 is merely representative of general functions that may be associated with such devices, and also that fixed computing systems similarly include computing circuitry to perform such operations.

The user apparatus 500 may include, for example, a mobile apparatus, mobile phone, mobile communication device, mobile computer, laptop computer, desk top computer, phone device, video phone, conference phone, television apparatus, digital video recorder (DVR), set-top box (STB), radio apparatus, audio/video player, game device, positioning device, digital camera/camcorder, and/or the like, or any combination thereof. Further the user apparatus 500 may include features of the mobile apparatus 102 shown and described in FIGS. 1A-B, 2, and 3.

The processing unit 502 controls the basic functions of the apparatus 500. Those functions may be configured as instructions stored in a program storage/memory 504. In an example embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out operations in accordance with the present invention may also be provided via computer program product, computer-readable medium, and/or be transmitted to the mobile apparatus 500 via data signals (e.g., downloaded electronically via one or more networks, such as the Internet and intermediate wireless networks).

The mobile apparatus 500 may include hardware and software components coupled to the processing/control unit 502. The mobile apparatus 500 may include multiple network interfaces 506 for maintaining any combination of wired or wireless data connections. The network interfaces 506 may include wireless data transmission circuitry such as a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc.

The network interface 506 may include transceiver, generally coupled to an antenna 510 that transmits the outgoing radio signals and receives the incoming radio signals associated with the wireless device. These components may enable the apparatus 500 to join in one or more communication networks 508, including mobile service provider networks, local networks, and public infrastructure networks such as the Internet. The network interface 506 may also include software modules for handling one or more network common network data transfer protocols, such as SSDP, HTTP, FTP, SMTP, SMS, MMS, etc.

The mobile apparatus 500 may also include an alternate network/data interface 516 coupled to the processing/control unit 502. The alternate data interface 516 may include the ability to communicate via secondary data paths using any type of data transmission medium, including wired and wireless mediums. Examples of alternate data interfaces 516 include USB, Bluetooth, RFID, Ethernet, 502.11 Wi-Fi, IRDA, Ultra Wide Band, WiBree, GPS, etc. These alternate interfaces 516 may also be capable of communicating via the networks 508, or via direct and/or peer-to-peer communications links.

The processor 502 is also coupled to user-interface hardware 518 associated with the mobile terminal. The user-interface 518 of the mobile terminal may include a display 520, such as a light-emitting diode (LED) and/or liquid crystal display (LCD) device. The user-interface hardware 518 also may include a transducer 524, such as an input device capable of receiving user inputs. The transducer 522 may also include sensing devices capable of measuring local conditions (e.g., location temperature, acceleration, orientation, proximity, etc.) and producing media (e.g., text, still pictures, video, sound, etc). Other user-interface hardware/software may be included in the interface 518, such as keypads, speakers, microphones, voice commands, switches, touch pad/screen, pointing devices, trackball, joystick, vibration generators, lights, accelerometers, etc. These and other user-interface components are coupled to the processor 502 as is known in the art.

The program storage/memory 504 includes operating systems for carrying out functions and applications associated with functions on the mobile apparatus 500. The program storage 504 may include one or more of read-only memory (ROM), flash ROM, programmable and/or erasable ROM, random access memory (RAM), subscriber interface module (SIM), wireless interface module (WIM), smart card, hard drive, computer program product, and removable memory device. The storage/memory 504 may also include one or more hardware interfaces 523. The interfaces 523 may include any combination of operating system drivers, middleware, hardware abstraction layers, protocol stacks, and other software that facilitates accessing hardware such as user interface 518, alternate interface 516, and network hardware 506.

The storage/memory 504 of the mobile apparatus 500 may also include specialized software modules for performing functions according to example embodiments of the present invention. For example, the program storage/memory 504 includes a peer-to-peer interface 524 that interfaces with other peers on an ad-hoc network, e.g., UPnP or similar. The apparatus 500 may include standard UPnP functional modules, here shown as control point module 526. The control point module 526 enables, among other things, selecting media from servers and directing the media to be rendered on target devices. A machine visualization module 530 may assist in selecting media and/or renderers by matching images or other measured features to known images of a target.

In order to determine a current target object, the machine visualization module 530 may interact with one or more of the transducers 522 to sense physical characteristics of the object. This sensed data may be processed (e.g., to distill certain features used by machine learning algorithms) and compared to a local and/or remote database 532, 534 via a database interface 536. The remote database 534 may be on a local network (e.g., provided from target peer devices) or be located on public networks such as the Internet. If the machine visualization module 530 matches sensed data with known data, this can be used by the control point module 526, e.g., to direct the rendering of date via the networks 508.

The mobile apparatus 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

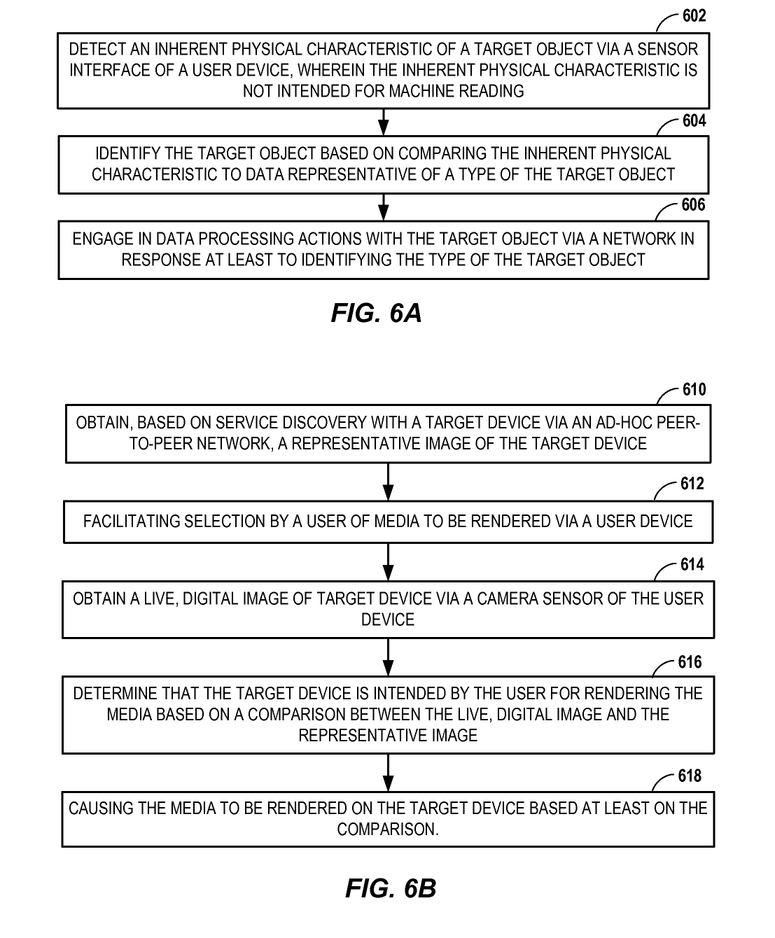

In reference now to FIG. 6A, a flowchart illustrates a procedure according to an example embodiment of the invention. The procedure involves detecting 602 an inherent physical characteristic of a target object via a sensor of a user device. The inherent physical characteristic is not intended for machine reading, and may be any combination of overall appearance of a target device, an as-manufactured physical configuration of a device, sounds, patterns colors, etc. The target object is identified 604 based on comparing the inherent physical characteristic to data representative of a type of the target object. The representative data may include any combination of stored images, features, landmarks, geometry, mathematical models, etc. capable of assisting in machine recognition of the sensed physical characteristic. The “type” of the target object may include a model number, capabilities list, UID, or similar identifier that allows identifying the target via a network. In response at least to identifying 604 the type of the target object, data processing actions are engaged in 606 with the target object via a network.

In FIG. 6B, a flowchart illustrates another procedure according to an example embodiment of the invention. The procedure involves obtaining 610, based on service discovery with a target device via an ad-hoc peer-to-peer network, a representative image of the target device. Selection by a user of media to be rendered is facilitated 612 via a user device. A live, digital image of target device is obtained 614 via a camera sensor of the user device. It is determined 616 that the target device is intended by the user for rendering the media based on a comparison between the live, digital image and the representative image. The media is then caused 618 to be rendered on the target device based at least on the comparison.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. An apparatus, comprising:
at least one processor and at least one memory including computer program code, the at least one memory and the computer program code configured to, with the at least one processor, cause the apparatus at least to perform:
detect an inherent physical characteristic of a target object via a sensor, wherein the inherent physical characteristic is not intended for machine reading;
identify the target object based on comparing the inherent physical characteristic to data representative of a type of the target object; and
engage in data processing actions with the target object via a local network in response at least to identifying the type of the target object.

2. The apparatus of claim 1, wherein the inherent physical characteristic of the target object comprises an overall appearance of a target device.

3. The apparatus of claim 1, wherein the inherent physical characteristic comprises an as-manufactured physical configuration of a device.

4. The apparatus of claim 1, wherein detecting the inherent physical characteristic of the target object via the sensor comprises capturing an image of the target object, and wherein identifying the target object comprises comparing the image to a stored image.

5. The apparatus of claim 4, wherein the stored image comprises a previously captured image of the target object obtained via the sensor.

6. The apparatus of claim 4, wherein the stored image comprises a previously captured image of an equivalent object.

7. The apparatus of claim 1, wherein the data representative of the type of the target object comprises one or more of a mathematical model of geometry of the target object and feature data of an image of the target object.

8. The apparatus of claim 1, wherein the target object comprises a peer device of the apparatus, and wherein the processor further causes the apparatus to obtain the data representative of the type of the target object through service discovery via an ad-hoc, peer-to-peer network.

9. The apparatus of claim 1, wherein the target object comprises a media renderer, and wherein engaging in data processing actions with the target object via the local network comprises sending media to the media renderer to be rendered.

10. A method, comprising:
detecting an inherent physical characteristic of a target object via a sensor of a user device, wherein the inherent physical characteristic is not intended for machine reading;
identifying the target object based on comparing the inherent physical characteristic to data representative of a type of the target object; and
engaging in data processing actions with the target object via a local network in response at least to identifying the type of the target object.

11. The method of claim 10, wherein the inherent physical characteristic of the target object comprises an overall appearance of a target device.

12. The method of claim 10, wherein the inherent physical characteristic comprises an as-manufactured physical configuration of a device.

13. The method of claim 10, wherein detecting the inherent physical characteristic of the target object via the sensor comprises capturing an image of the target object, and wherein identifying the target object comprises comparing the image to a stored image.

14. The method of claim 13, wherein the stored image comprises a previously captured image of the target object obtained via the sensor.

15. The method of claim 13, wherein the stored image comprises a previously captured image of an equivalent object.

16. The method of claim 10, wherein the data representative of the type of the target object comprises one or more of a mathematical model of geometry of the target object and feature data of an image of the target object.

17. The method of claim 10, wherein the target object comprises a peer device of the apparatus, and wherein the method further comprises obtaining the data representative of the type of the target object through service discovery via an ad-hoc, peer-to-peer network.

18. The method of claim 10, wherein the target object comprises a media renderer, and wherein engaging in data processing actions with the target object via the local network comprises sending media to the media renderer to be rendered.

19. A non-transitory computer-readable medium storing instructions that are executable by a processor to perform the method of claim 10.

20. A method comprising:
obtaining, based on service discovery with a target device via an ad-hoc peer-to-peer network, a representative image of the target device;
facilitating selection by a user of media to be rendered via a user device;
obtaining a live, digital image of target device via a camera sensor of the user device;
determining that the target device is intended by the user for rendering the media based on a comparison between the live, digital image and the representative image; and
causing the media to be rendered on the target device based at least on the comparison.
